(19) United States
(12) Patent Application Publication
(10) Pub. No.: US 2026/0245009 A1
(43) Pub. Date: Aug. 20, 2026

(54) MANAGEMENT DEVICE, MANAGEMENT METHOD, AND MANAGEMENT PROGRAM

(71) Applicant: NIPPON TELEGRAPH AND TELEPHONE CORPORATION, Tokyo (JP)

(72) Inventors: Ikuko TAKAGI, Tokyo (JP); Momoko FUJITA, Tokyo (JP)

(73) Assignee: NIPPON TELEGRAPH AND TELEPHONE CORPORATION, Tokyo (JP)

(21) Appl. No.: 18/843,237

(22) PCT Filed: Mar. 1, 2022
(86) PCT No.: PCT/JP2022/008630

§ 371 Date: Aug. 31, 2024

(51) Int. Cl. G06Q 10/0631

(52) U.S. Cl. CPC G06Q 10/063116

(57) ABSTRACT

An acquisition unit (15a) acquires task information representing work-related operations for each person in charge and a responsibility period of each person in charge. A revision unit (15b) revises the incomplete date information in each piece of task information by using date information included in the acquired task information and the responsibility period.

### TECHNICAL FIELD

The present invention relates to a management device, a management method, and a management program.

### BACKGROUND ART

List type task management tools based on spreadsheets in order to hand over work knowledge have been known (see Non Patent Literature 1).

### CITATION LIST

### Non Patent Literature

Non Patent Literature 1:“Excel deno tasuku kanri no hoho/kanrihyo no tsukuri kata” (in Japanese) (Method for Task Management in Excel/Method of Creating Management Table) [online], 2019, Jooto, [searched Jan. 31, 2022], Internet <URL:https://www.jooto.com/contents/excel-task-management/>

### SUMMARY OF INVENTION

### Technical Problem

However, according to the related art, hand-over of work among multiple generations of persons in charge may be challenging. For example, in the related art, it is assumed that tasks are handed over 1:1 from a hand-over source to a hand-over destination. Therefore, for example, in order for a person in charge two generations ahead to understand a task of a person in charge two generations ago as knowledge, management of a separate spreadsheet is involved.

Further, since it is difficult to systematically handle information regarding dates of tasks, the occurrence (execution) frequency of tasks useful for creating items to be handed over has to be separately and manually examined and estimated. Furthermore, since task management based on spreadsheets is assumed to be carried out by manual input, input omission may occur depending on the busyness of work and the task status. Therefore, it is particularly difficult to accumulate knowledge regarding “when does work occurs”.

The present invention is contrived in view of the above problems, and an object thereof is to easily perform hand-over of work among multiple generations of persons in charge.

### Solution to Problem

In order to solve the above-described problems and achieve the object, a management device according to the present invention includes: an acquisition unit that acquires task information representing work-related operations for each person in charge and a responsibility period of each person in charge; and a revision unit that revises incomplete date information in each piece of task information by using date information included in the acquired task information and the responsibility period.

### Advantageous Effects of Invention

According to the present invention, it is possible to easily hand over work among multiple generations of persons in charge.

### BRIEF DESCRIPTION OF DRAWINGS

FIG. 1 is a diagram for describing an overview of a management device of the present embodiment.

FIG. 2 is a diagram for describing an overview of the management device of the present embodiment.

FIG. 3 is a diagram for describing an overview of the management device of the present embodiment.

FIG. 4 is a schematic diagram illustrating a schematic configuration of the management device.

FIG. 5 is a diagram illustrating a data configuration of a person-in-charge table.

FIG. 6 is a diagram illustrating a data configuration of a task management table.

FIG. 7 is a diagram illustrating a data configuration of a task frequency table.

FIG. 8 is a diagram for describing a task management sheet.

FIG. 9 is a diagram for describing processing of a retrieval unit.

FIG. 10 is a flowchart showing a management processing procedure.

FIG. 11 is a flowchart showing a management processing procedure.

FIG. 12 is a flowchart showing a management processing procedure.

FIG. 13 is a flowchart showing a management processing procedure.

FIG. 14 is a diagram showing an example of a computer that executes a management program.

### DESCRIPTION OF EMBODIMENTS

Hereinafter, an embodiment of the present invention will be described in detail with reference to the drawings. Note that the present invention is not limited by this embodiment. Further, in the description of the drawings, the same portions are denoted by the same reference numerals.

### Overview of Management Device

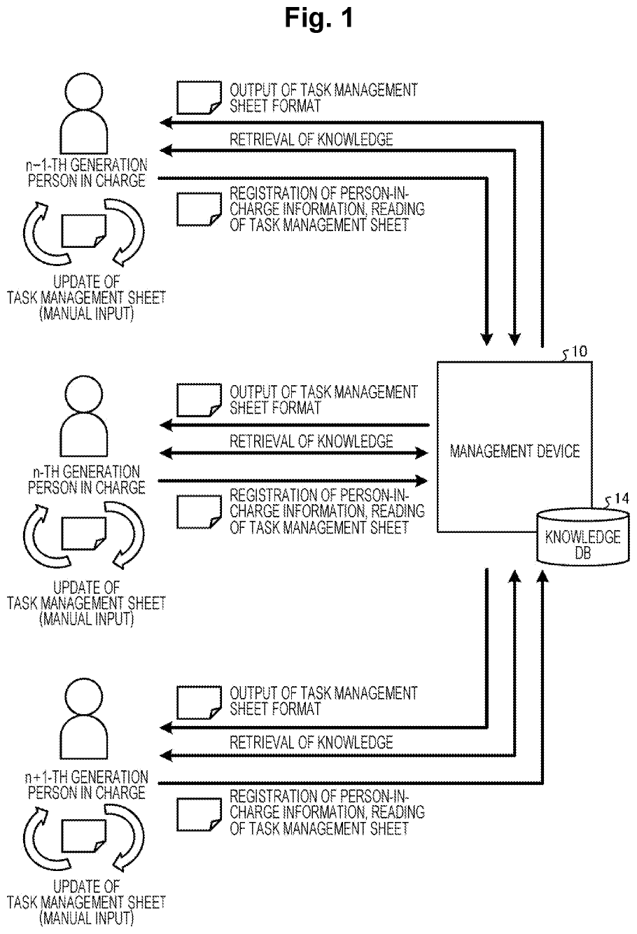

FIGS. 1 to 3 are diagrams for describing an overview of a management device of the present embodiment. First, as shown in FIG. 1, a management device 10 creates a task management sheet where each person in charge lists tasks for each piece of work, and accumulates the created sheet in a knowledge database (DB) 14. The management device 10 revises the data on the start date and the end date of a task in the knowledge DB 14 on the basis of the date information in the task management sheet. In addition, the management device 10 estimates the execution frequency of each task on the basis of the occurrence date, task name, and the like of each task in the task management sheet.

In addition, the management device 10 retrieves and presents a related task from the knowledge DB 14 using a task execution timing, a person in charge, or the like as a query. In particular, the management device 10 extracts a predecessor's unfinished task and outputs it as an item to be handed over to a successor. Accordingly, the management device 10 can mediate the task management sheet representing work knowledge among multiple generations of persons in charge.

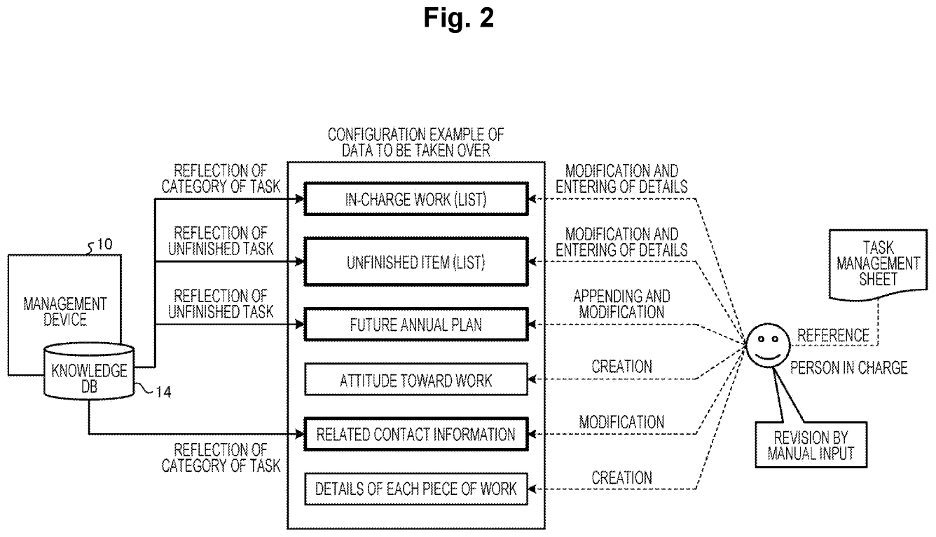

Specifically, as illustrated in FIG. 2, each person in charge can easily create data to be handed over, such as a list of in-charge work, a list of unfinished items, a future annual plan, attitude toward work, related contact information, and details of each piece of work on the basis of the task information accumulated in the knowledge DB 14.

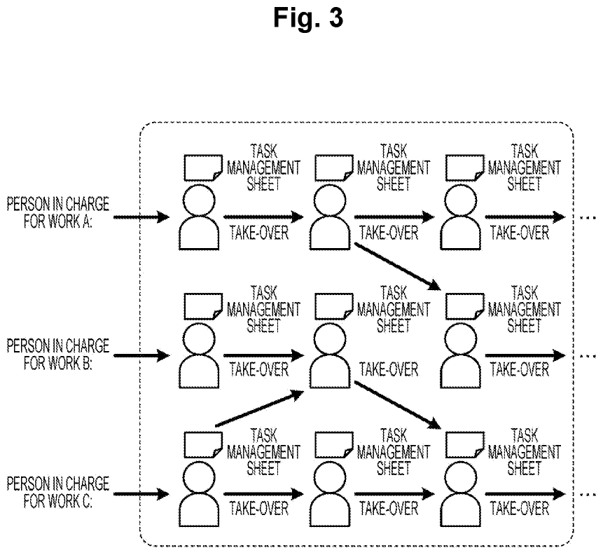

In addition, by managing multiple pieces of work of a team in the knowledge DB 14, the management device 10 can smoothly hand over work even in a case where, unlike a predecessor, roles are handed over among multiple successors, as illustrated in FIG. 3.

### Configuration of Management Device

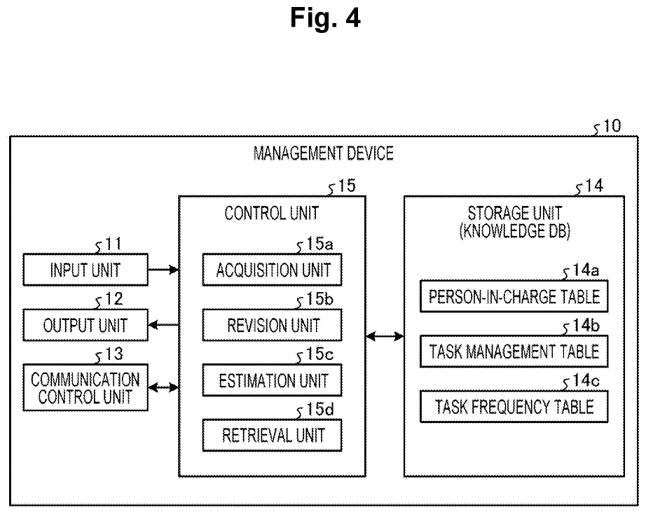

FIG. 4 is a schematic diagram illustrating a schematic configuration of the management device 10. As illustrated in FIG. 1, the management device 10 of the present embodiment is realized by a general-purpose computer such as a personal computer, and includes an input unit 11, an output unit 12, a communication control unit 13, a storage unit 14, and a control unit 15.

The input unit 11 is realized by using an input device such as a keyboard or a mouse and inputs various types of instruction information such as processing start to the control unit 15 in response to an input operation of an operator. The output unit 12 is realized by a display device such as a liquid crystal display, a printing device such as a printer, or the like. For example, the output unit 12 displays a result of management processing to be described later.

The communication control unit 13 is realized by a network interface card (NIC) or the like and controls communication between the control unit 15 and an external device via a telecommunication line such as a local area network (LAN) or the Internet. For example, the communication control unit 13 controls communication between the control unit 15 and an information terminal operated by a person in charge of work, a server that manages person-in-charge information, or the like.

The storage unit 14 is realized by a semiconductor memory element such as a random access memory (RAM) or a flash memory, or a storage device such as a hard disk or an optical disc. In the storage unit 14, a processing program for operating the management device 10, data used during execution of the processing program, and the like are stored in advance, or temporarily stored each time processing is performed. The storage unit 14 may be configured to communicate with the control unit 15 via the communication control unit 13.

In the present embodiment, the storage unit 14 stores, as knowledge DB, a person-in-charge table 14a, a task management table 14b, and a task frequency table 14c.

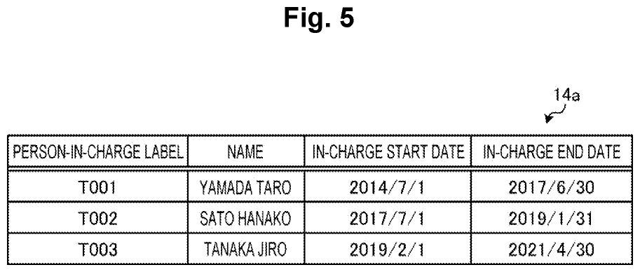

Here, FIG. 5 is a diagram illustrating a data configuration of the person-in-charge table. As illustrated in FIG. 5, the person-in-charge table 14a includes a name of a person in charge of work, an in-charge start date, and an in-charge end date with a person-in-charge label as key information.

The person-in-charge label represents information for identifying a person in charge. The in-charge start date and the in-charge end date indicate a responsibility period of the person in charge for the work. In FIG. 5, for example, the person-in-charge label “T001”, the name “Taro Yamada”, the in-charge start date “2014 Jul. 1”, and the in-charge end date “2017 Jun. 30” are illustrated.

In the present embodiment, the person-in-charge table 14a is acquired from an information terminal operated by a person in charge of work, a server that manages person-in-charge information, or the like in advance before management processing to be described later, and is stored in the storage unit 14. The information terminal may be implemented in the same hardware as the management device 10.

Furthermore, the person-in-charge table 14a is not limited to being stored in the storage unit 14, and may be collected when management processing to be described later is executed, for example. In that case, for example, the acquisition unit 15a to be described later may collect, prior to the processing, the information in the person-in-charge table 14a from an information terminal of a person in charge, a server that manages person-in-charge information, or the like.

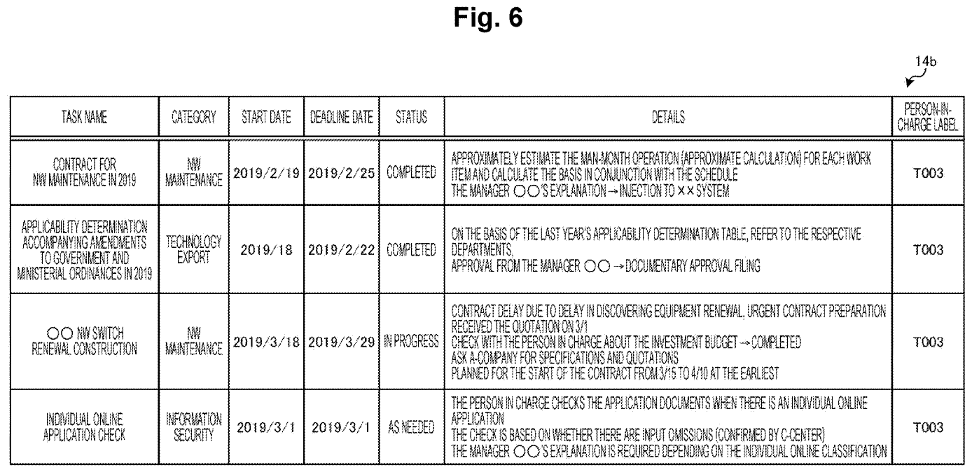

In addition, FIG. 6 is a diagram illustrating a data configuration of the task management table. The task management table 14b is generated by management processing to be described later. As illustrated in FIG. 6, the task management table 14b includes task information such as a task name, a category, a start date, a deadline date, a status, and details, similarly to a task management sheet to be described later. In addition, the task management table 14b includes a person-in-charge label.

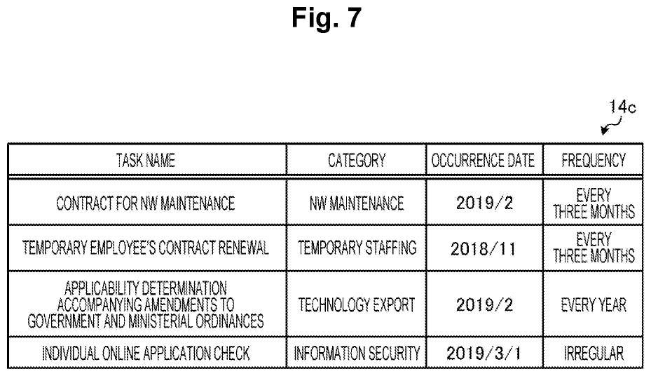

In addition, FIG. 7 is a diagram illustrating a data configuration of the task frequency table. As illustrated in FIG. 7, the task frequency table 14c includes information such as a task name, a category, an occurrence date, and a frequency. The task frequency table 14c is generated by management processing to be described later.

The description returns to FIG. 4. The control unit 15 is realized by using a central processing unit (CPU) or the like and executes a processing program stored in the memory. Accordingly, the control unit 15 functions as an acquisition unit 15a, a revision unit 15b, an estimation unit 15c, and a retrieval unit 15d and executes management processing as illustrated in FIG. 4. Each or some of these functional units may be implemented in different sets of hardware. For example, the retrieval unit 15d may be implemented in a retrieval device different from other functional units. The control unit 15 may also include other functional units.

That is, the management device 10 may be in any of a standalone form realized by one computer, an on-premise form realized by two or more on-premise computers, and a cloud form realized by two or more computers including one or more off-premise computers.

The acquisition unit 15a acquires task information representing work-related operations for each person in charge and a responsibility period of each person in charge. Specifically, the acquisition unit 15a acquires a task management sheet that is task information representing a list of tasks of each person in charge, via the input unit 11, or from an information terminal of each person in charge via the communication control unit 13. The acquisition unit 15a may acquire the task management sheet from a server or the like that collects the task management sheet from the information terminal of the person in charge via the communication control unit 13. The acquisition unit 15a accumulates the acquired task information included in the task management sheet for each person in charge as the task management table 14b.

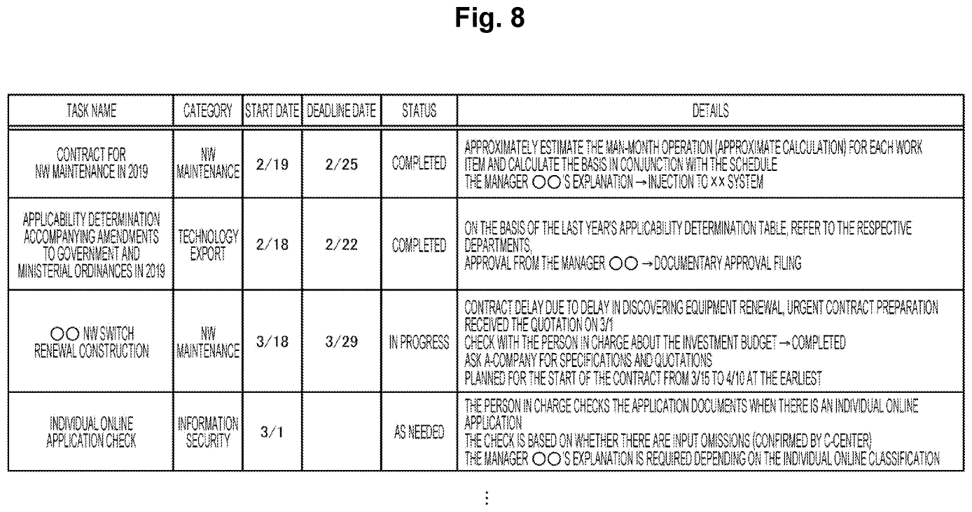

Here, FIG. 8 is a diagram for describing the task management sheet. As illustrated in FIG. 8, the task management sheet includes task information such as a task name, a category, a start date, a deadline date, a status, and details.

The task name represents information in a text format indicating the name of a task. In addition, the category represents information in a text format indicating the classification of a task. In FIG. 8, the task name “2019 NW maintenance contract”, the category “NW maintenance”, and the like are illustrated.

The start date represents information in a date format indicating a target date on which a task should be started, and the deadline date represents information in a date format indicating a date on which a task should be completed. In FIG. 8, the start date “February 2019” and the deadline date “February 2025”, and the like are illustrated.

The status represents choice type information indicating the progress of a task, such as “completed”, “in progress”, “as needed”, “not needed”, “on hold”, “scheduled”, and “waiting for answer”, and a person in charge updates the status according to the status of the task. The details represent detailed information in a text format related to a task, such as memorandum on the progress of the task, devised points, and items to be handed over, and can be freely filled in by a person in charge.

Each person in charge adds the information to the task management sheet of the information terminal in time series each time a task for his/her work occurs. Then, the acquisition unit 15a collects the task management sheet filled in by each person in charge. In addition, the acquisition unit 15a acquires, from the person-in-charge table 14a, the responsibility period of each person in charge including an in-charge start date and an in-charge end date.

The description returns to FIG. 4. The revision unit 15b revises the incomplete date information in each piece of task information by using the date information included in the acquired task information and the responsibility period of each person in charge.

Specifically, the revision unit 15b revises the date information set in the task management table 14b by using the task management sheet shown in FIG. 8 and the responsibility period of each person in charge acquired from the person-in-charge table 14a shown in FIG. 5.

For example, the revision unit 15b revises the year so as to be in the format of year/month/day and registers the revised information in the task management table 14b so that, in the task management sheet of the person in charge shown in FIG. 6, the start date and the deadline date in the format of month/day correspond to the responsibility period of the person in charge. For example, in the task management sheet illustrated in FIG. 8, the start date and the deadline date are in the format of month/day.

Meanwhile, in the task management table 14b illustrated in FIG. 6, with respect to the task information with the person-in-charge label “T003”, the start date and the deadline date are set in the format of year/month/day with the year “2019/” revised in consideration of the time-series order of tasks and the period from the in-charge start date “2019 Feb. 1” to the in-charge end date “2021 Apr. 30” that is the responsibility period of the person in charge.

In addition, with respect to the task information in which the status is “not needed”, “on hold”, or the like and thus it is not necessary to set a specific period for task execution, the revision unit 15b sets both the start date and the deadline date to null.

In addition, with respect to the task information in which the status is “as needed”, the task continuously occurs during the responsibility period of the person in charge. Therefore, the revision unit 15b sets the in-charge start date as the start date and sets the in-charge end date as the deadline date. In addition, in a case where the deadline date is not filled in the task management sheet, the revision unit 15b temporarily sets a date such as one year after the current date (processing date).

In addition, the deadline date in the task information is information set on the basis of the contents of the task, regardless of the input order of the task. It may be set beyond the period for which the person in charge takes responsibility. Therefore, the revision unit 15b does not revise the deadline date not filled in the task management sheet.

The description returns to FIG. 4. The estimation unit 15c estimates the execution frequency of each task by using the task name and the occurrence date included in the task information. For example, the estimation unit 15c extracts noun sets by morpheme analysis with respect to the task name of each piece of task information in the task management table 14b. The estimation unit 15c calculates similarity among the noun sets of the task names. For example, the estimation unit 15c calculates the similarity among the noun sets by using the Szymkiewicz-Simpson coefficient or the like that is an index of the strength of the frequency of nouns co-occurring in the document.

The estimation unit 15c classifies task information in which the calculated similarity is equal to or greater than a predetermined threshold as the same tasks.

Furthermore, the estimation unit 15c estimates, in the task information classified as the same tasks, a noun having the highest appearance frequency as a task name of the classification.

In addition, the estimation unit 15c arranges the task information classified as the same tasks in time series and estimates the execution frequency.

Specifically, for example, the occurrence date in each piece of task information, that is, the start date is set in the format of execution year/month/day for each task, and the estimation unit 15c calculates the average of and variation in differences (execution intervals) among the dates of execution year/month/day.

With respect to the day, in a case where the calculated variation in differences is less than a predetermined threshold, the estimation unit 15c estimates that there is periodicity with respect to the day, and sets the task frequency in the task frequency table 14c shown in FIG. 7. For example, the estimation unit 15c sets the year/month/day of a first task as the occurrence date in the task frequency table 14c, and sets the average of differences as the frequency.

Meanwhile, with respect to the day, in a case where the calculated variation in differences is equal to or greater than the predetermined threshold, the estimation unit 15c checks the periodicity with respect to the month. That is, with respect to the month, in a case where the calculated variation in differences is less than a predetermined threshold, the estimation unit 15c estimates that there is periodicity with respect to the month, and sets the task frequency in the task frequency table 14c.

For example, the estimation unit 15c sets the year/month of a first task as the occurrence date in the task frequency table 14c, and sets the average of differences as the frequency.

Meanwhile, with respect to the month, in a case where the calculated variation in differences is equal to or greater than the predetermined threshold, the estimation unit 15c checks the periodicity with respect to the year.

That is, with respect to the year, in a case where the calculated variation in differences is less than a predetermined threshold, the estimation unit 15c estimates that there is periodicity with respect to the year, and sets the task frequency in the task frequency table 14c.

For example, the estimation unit 15c sets the year of a first task as the occurrence date in the task frequency table 14c, and sets the average of differences as the frequency.

Meanwhile, with respect to the year, in a case where the calculated variation in differences is equal to or greater than the predetermined threshold, the estimation unit 15c estimates that there is no periodicity in the execution of the task, and sets “irregular” as the frequency in the task frequency table 14c.

The estimation of the task frequency by the estimation unit 15c is not limited to using the task name. For example, the estimation unit 15c may estimate the task frequency by performing the same processing as described above for the category instead of the task name.

The retrieval unit 15d retrieves task information including a designated task or person in charge from the revised task information. Specifically, the retrieval unit 15d retrieves the task management table 14b using a task execution timing, a task category, a person in charge, or the like as a query. Accordingly, a successor can extract a task related to his/her work.

The retrieval unit 15d extracts an unfinished task of a previous person in charge. For example, the retrieval unit 15d extracts an unfinished task whose status in the task management table 14b is “in progress”, “scheduled”, “on hold” or the like and outputs the task to a successor.

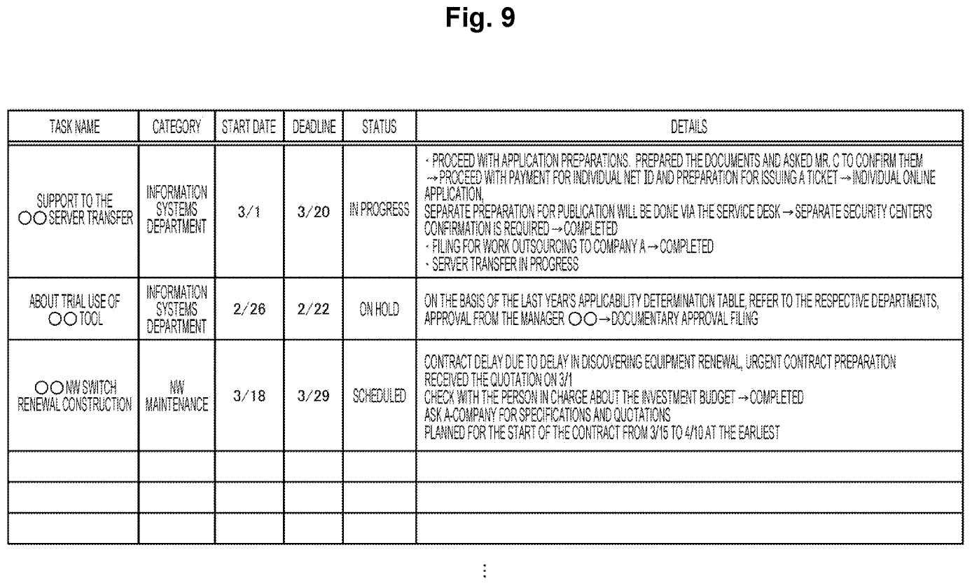

Here, FIG. 9 is a diagram for describing processing of the retrieval unit. As shown in FIG. 9, the retrieval unit 15d can output an unfinished task of a predecessor to a successor. In the example shown in FIG. 9, the extracted unfinished task is output in the form of the task management sheet shown in FIG. 8. Accordingly, hand-over to the successor can be easily performed.

### Management Processing

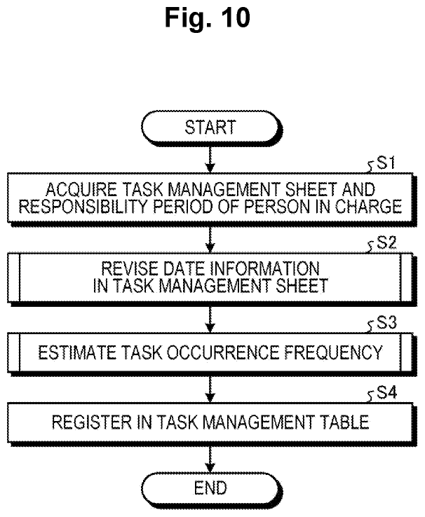

Next, management processing by the management device 10 according to the present embodiment will be described with reference to FIGS. 10 to 13. FIGS. 10 to 13 are flowcharts showing a management processing procedure. At the beginning, the flowchart of FIG. 10 is started at, for example, a timing at which a user performs an operation input for a start instruction.

First, the acquisition unit 15a acquires a task management sheet for each person in charge and person-in-charge information including a responsibility period of each person in charge (step S1).

Next, the revision unit 15b revises the incomplete date information in each piece of task information by using the date information included in the acquired task information and the responsibility period of each person in charge (step S2). In addition, the estimation unit 15c estimates the execution frequency of each task by using the task name and the occurrence date included in the task information (step S3).

In addition, the acquisition unit 15a generates the task management table 14b and accumulates the information in the acquired task management sheet. In addition, the acquisition unit 15a generates the person-in-charge table 14a using the person-in-charge information. Then, the revision unit 15b updates the task management table 14b with the revised date information. In addition, the estimation unit 15c generates the task frequency table 14c and sets the estimated execution frequency of each task (step S4). In this manner, the series of management processing ends.

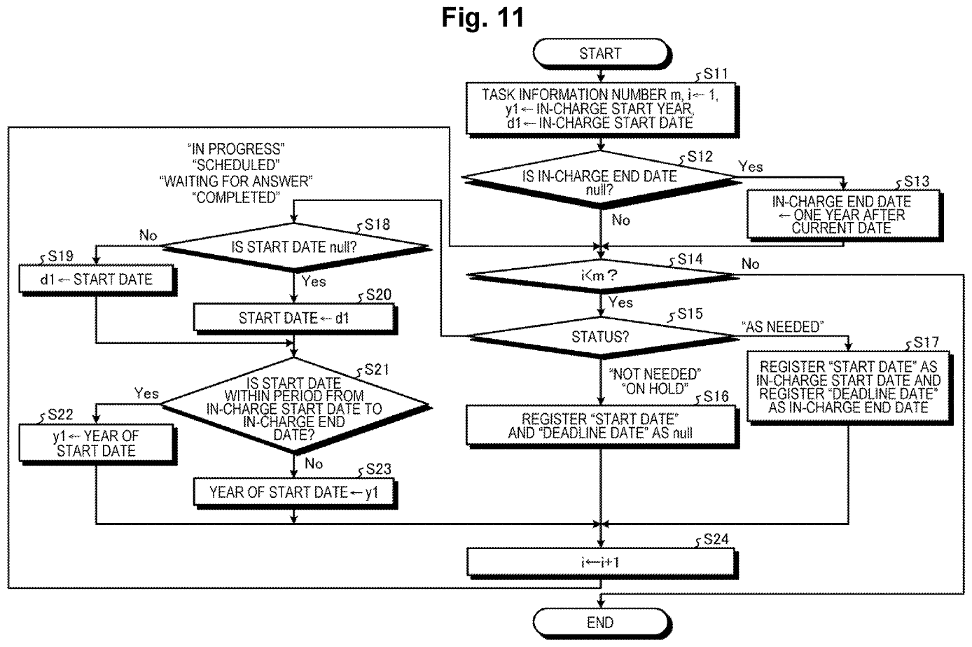

Next, FIG. 11 shows the processing procedure of step S2 shown in FIG. 10. First, the revision unit 15b sets y1 as an in-charge start year and sets d1 as an in-charge start date with respect to i=1 in i-th (1≤i≤m) task information in the task management sheet for each person in charge (step S11). In addition, in a case where an in-charge end date of the person in charge is null (Yes in step S12), the in-charge end date is temporarily set to, for example, one year after the current date (step S13).

Meanwhile, in a case where the in-charge end date of the person in charge is not null (No in step S12) and i is less than m (Yes in step S14), the revision unit 15b checks the status (step S15).

In a case where the status is any one of “in progress”, “scheduled”, “waiting for answer”, and “completed” and the start date is not null (No in step S18), the revision unit 15b sets d1 as the start date (step S19) and advances the processing to step S21. Meanwhile, in a case where the start date is null (Yes in step S18), the revision unit 15b sets d1 as the start date (step S20) and advances the processing to step S21.

Next, in a case where the start date is within the responsibility period of the person in charge (Yes in step S21), the revision unit 15b sets y1 as the year of the start date (step S22) and advances the processing to step S24. Meanwhile, in a case where the start date is out of the responsibility period of the person in charge (No in step S21), the revision unit 15b sets the year of the start date as y1 and advances the processing to step S24.

In a case where the status is either “not needed” or “on hold”, the revision unit 15b sets the start date and the deadline date to null (step S16) and advances the processing to step S24.

In a case where the status is “as needed”, the revision unit 15b sets the start date as the in-charge start date and sets the deadline date as the in-charge end date (step S17) and advances the processing to step S24.

In the processing of step S24, i is changed to i+1 and the processing returns to step S14. Then, in a case of i=m (No in step S14), the revision unit 15b ends the series of processing.

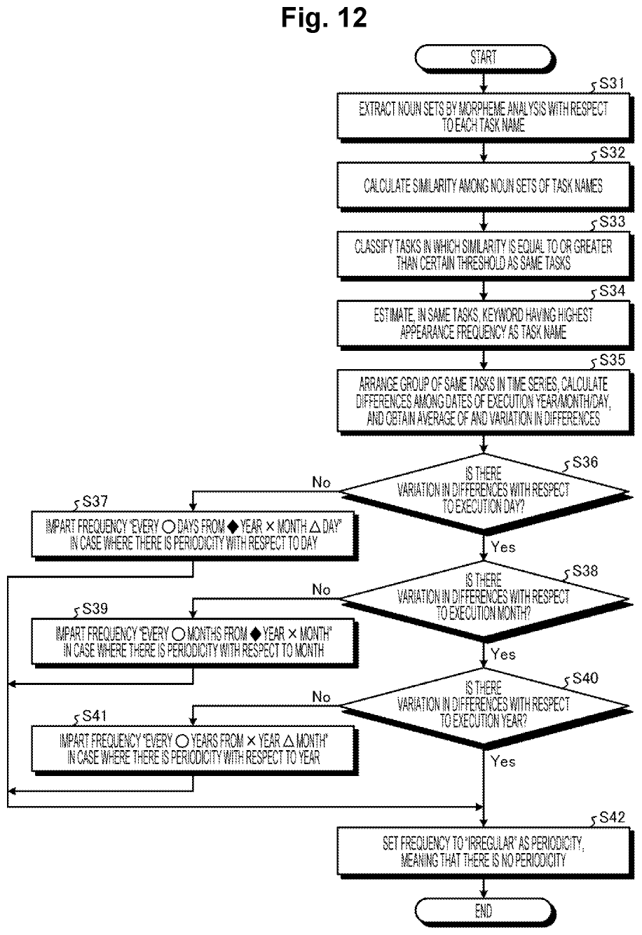

In addition, FIG. 12 shows the processing procedure of step S3 shown in FIG. 10. First, the estimation unit 15c extracts noun sets by morpheme analysis with respect to the task name of each piece of task information in the task management table 14b (step S31). The estimation unit 15c calculates similarity among the noun sets of the task names (step S32). For example, the estimation unit 15c calculates the similarity among the noun sets by using the Szymkiewicz-Simpson coefficient or the like that is an index of the strength of the frequency of nouns co-occurring in the document.

The estimation unit 15c classifies task information in which the calculated similarity is equal to or greater than a predetermined threshold as the same tasks (step S33). Furthermore, the estimation unit 15c estimates, in the task information classified as the same tasks, a noun having the highest appearance frequency as a task name of the classification (step S34).

In addition, the estimation unit 15c arranges the task information classified as the same tasks in time series and estimates the execution frequency. For example, the occurrence date (start date) in each piece of task information is set in the format of execution year/month/day for each task, and the estimation unit 15c calculates the average of and variation in differences (execution intervals) among the dates of execution year/month/day (step S35).

With respect to the day, in a case where the calculated variation in differences is less than a predetermined threshold (No in step S36), the estimation unit 15c estimates that there is periodicity with respect to the day, and sets the task frequency such as “every O days from year x month A day” in the task frequency table 14c (step S37). For example, the estimation unit 15c sets the year/month/day of a first task as the occurrence date in the task frequency table 14c, and sets the average of differences as the frequency. In this manner, the series of processing ends.

Meanwhile, with respect to the day, in a case where the calculated variation in differences is equal to or greater than the predetermined threshold (Yes in step S36), the estimation unit 15c checks the periodicity with respect to the month. That is, with respect to the month, in a case where the calculated variation in differences is less than a predetermined threshold (No in step S38), the estimation unit 15c estimates that there is periodicity with respect to the month, and sets the task frequency “every O months from year x month” in the task frequency table 14c (step S39). For example, the estimation unit 15c sets the year/month of a first task as the occurrence date in the task frequency table 14c, and sets the average of differences as the frequency. In this manner, the series of processing ends.

Meanwhile, with respect to the month, in a case where the calculated variation in differences is equal to or greater than the predetermined threshold (Yes in step S38), the estimation unit 15c checks the periodicity with respect to the year. That is, with respect to the year, in a case where the calculated variation in differences is less than a predetermined threshold (No in step S40), the estimation unit 15c estimates that there is periodicity with respect to the year, and sets the task frequency “every ◯ years from × year Δ month” in the task frequency table 14c (step S41). For example, the estimation unit 15c sets the year of a first task as the occurrence date in the task frequency table 14c, and sets the average of differences as the frequency. In this manner, the series of processing ends.

Meanwhile, with respect to the year, in a case where the calculated variation in differences is equal to or greater than the predetermined threshold (Yes in step S40), the estimation unit 15c estimates that there is no periodicity in the execution of the task, and sets “irregular” as the frequency in the task frequency table 14c (step S42). In this manner, the series of processing ends.

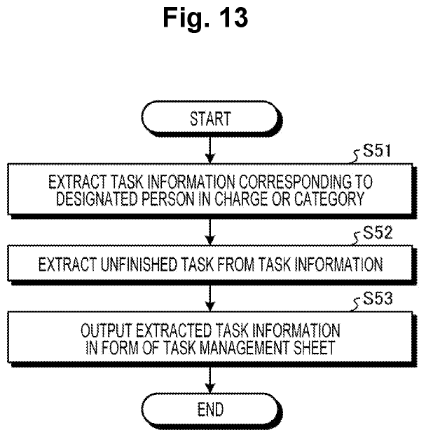

Furthermore, FIG. 13 shows the processing procedure of the retrieval unit 15d. The retrieval unit 15d retrieves task information including a designated task or person in charge from the revised task information. For example, the retrieval unit 15d extracts task information corresponding to a designated person in charge, such as a predecessor, and category from the task management table 14b (step S51).

In addition, the retrieval unit 15d extracts incomplete task information in which the status is “in progress”, “scheduled”, “waiting for answer”, or “as needed” from among the extracted task information (step S52).

Then, the retrieval unit 15d outputs the extracted task information to a successor in the form of the task management sheet (step S53). In this manner, the series of processing ends.

### Effects

As described above, in the management device 10 of the present embodiment, the acquisition unit 15a acquires task information representing work-related operations for each person in charge and a responsibility period of each person in charge. In addition, the revision unit 15b revises the incomplete date information in each piece of task information by using the date information included in the acquired task information and the responsibility period.

Accordingly, the management device 10 can estimate and revise the timing of the task information of which the input is omitted, and can manage the task information for multiple persons in charge in time series. Therefore, even in a case where, unlike a predecessor, roles are handed over among multiple successors, hand-over can be smoothly performed. In this manner, it is possible to easily hand over work by managing work knowledge among multiple generations of persons in charge.

In addition, the estimation unit 15c estimates the execution frequency of each task by using the task name and the occurrence date included in the task information.

Accordingly, it is possible for a successor to easily understand the occurrence frequency of the task to be handed over.

In addition, the retrieval unit 15d retrieves task information including a designated task or person in charge from the revised task information. Accordingly, a successor can easily extract a task related to his/her work.

The retrieval unit 15d extracts an unfinished task of a previous person in charge. Accordingly, hand-over of work to a successor can be more easily performed.

### Program

It is also possible to create a program in which processing executed by the management device 10 according to the above embodiment is described in a computer executable language. As an embodiment, the management device 10 can be implemented by installing a management program for executing the above management processing as packaged software or online software in a desired computer. For example, by causing an information processing apparatus to execute the above management program, the information processing apparatus can be caused to function as the management device 10. The information processing apparatus described here includes a desktop or laptop personal computer. In addition, the category of the information processing apparatus includes a mobile communication terminal such as a smartphone, a mobile phone, or a personal handyphone system (PHS), a slate terminal such as a personal digital assistant (PDA), and the like. Further, the function of the management device 10 may be implemented in a cloud server.

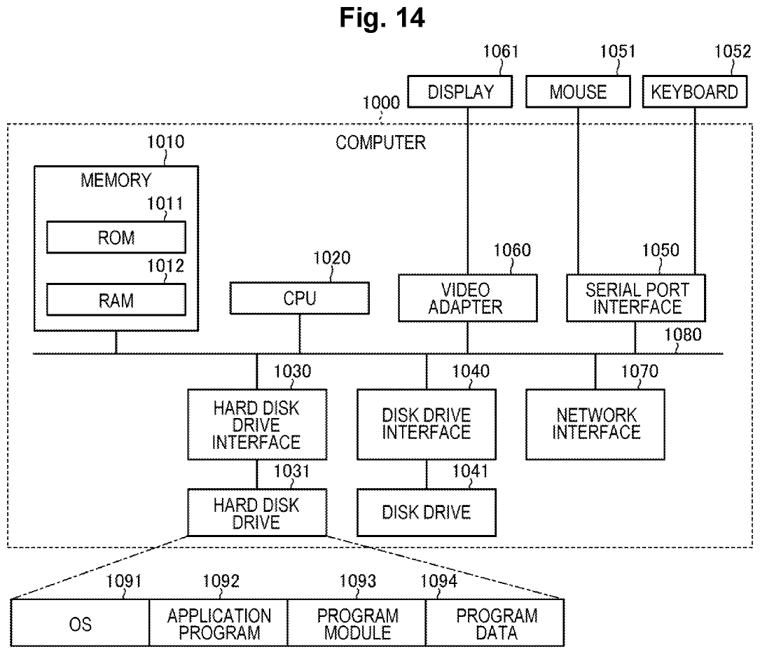

FIG. 14 is a diagram showing an example of a computer that executes the management program. A computer 1000 includes, for example, a memory 1010, a CPU 1020, a hard disk drive interface 1030, a disk drive interface 1040, a serial port interface 1050, a video adapter 1060, and a network interface 1070. These units are connected to each other via a bus 1080.

The memory 1010 includes a read-only memory (ROM) 1011 and a RAM 1012. The ROM 1011 stores, for example, a boot program such as a basic input output system (BIOS).

The hard disk drive interface 1030 is connected to a hard disk drive 1031. The disk drive interface 1040 is connected to a disk drive 1041. For example, a removable storage medium such as a magnetic disk or an optical disc is inserted into the disk drive 1041. The serial port interface 1050 is connected to, for example, a mouse 1051 and a keyboard 1052. The video adapter 1060 is connected to, for example, a display 1061.

Here, the hard disk drive 1031 stores, for example, an OS 1091, an application program 1092, a program module 1093, and program data 1094. Each piece of information described in the above embodiment is stored in, for example, the hard disk drive 1031 or the memory 1010.

In addition, the management program is stored in the hard disk drive 1031 as the program module 1093 in which commands to be executed by the computer 1000 are described, for example. Specifically, the program module 1093 in which each type of processing executed by the management device 10 described in the above embodiment is described is stored in the hard disk drive 1031.

In addition, data used for information processing by the management program is stored, for example, in the hard disk drive 1031 as the program data 1094. The CPU 1020 reads, into the RAM 1012, the program module 1093 and the program data 1094 stored in the hard disk drive 1031 as necessary and executes each procedure described above.

Note that the program module 1093 and the program data 1094 related to the management program are not limited to being stored in the hard disk drive 1031, and may be stored in, for example, a removable storage medium and read by the CPU 1020 via the disk drive 1041 or the like.

Alternatively, the program module 1093 and the program data 1094 related to the management program may be stored in another computer connected via a network such as a LAN or a wide area network (WAN) and read by the CPU 1020 via the network interface 1070.

Although the embodiments to which the present invention made by the present inventors is applied have been described above, the present invention is not limited by the description and the drawings which are parts of the disclosure of the embodiment of the present invention. In other words, other embodiments, examples, operational techniques, and the like made by those skilled in the art or the like on the basis of the present embodiment are all included in the scope of the present invention.

### REFERENCE SIGNS LIST

10 Management device
11 Input unit
12 Output unit
13 Communication control unit
14 Storage unit (Knowledge DB)
14a Person-in-charge table
14b Task management table
14c Task frequency table
15 Control unit
15a Acquisition unit
15b Revision unit
15c Estimation unit
15d Retrieval unit

1. A device comprising a processor configured to execute operations comprising:
acquiring task information representing work-related operation as a task of a person in charge and a responsibility period of the person in charge of the work-related operation; and
revising incomplete date information in an item in the task information by using date information included in the acquired task information and the responsibility period.

2. The device according to claim 1, the processor further configured to execute operations comprising:
estimating an execution frequency of the task by using a task name and an occurrence date included in the task information.

3. The device according to claim 1, the processor further configured to execute operations comprising:
retrieving the task information from the revised task information, wherein the task information comprises a designated task for the person in charge.

4. The device according to claim 3, wherein the retrieving further comprises extracting an unfinished task of a previous person in charge.

5. A computer-implemented method, comprising:
acquiring task information representing a work-related operation as a task of a person in charge and a responsibility period of the person in charge of the work-related operation; and
revising incomplete date information in an item in the task information by using date information included in the acquired task information and the responsibility period.

6. A computer-readable non-transitory recording medium storing a computer-executable program instructions that when executed by a processor cause a computer to execute operations comprising:
acquiring task information representing a work-related operation as a task of a person in charge and a responsibility period of the person in charge; and
revising incomplete date information in an item in the task information by using date information included in the acquired task information and the responsibility period.

7. The device according to claim 1, the processor further configured to execute operations comprising:
generating textual data describing the task for transferring the task from the person in charge of the task to another person.

8. The device according to claim 1, wherein the revising further comprises inserting a predetermined value to the incomplete date information of the task when the task indicates a task state of on-hold.

9. The computer-implemented method according to claim 5, further comprising:
estimating an execution frequency of the task by using a task name and an occurrence date included in the task information.

10. The computer-implemented method according to claim 5, further comprising:
retrieving the task information from the revised task information, wherein the task information comprises a designated task for the person in charge.

11. The computer-implemented method according to claim 10, further comprising:
wherein the retrieving further comprises extracting an unfinished task of a previous person in charge.

12. The computer-implemented method according to claim 5, further comprising:
generating textual data describing the task for transferring the task from the person in charge of the task to another person.

13. The computer-implemented method according to claim 5, wherein the revising further comprises inserting a predetermined value to the incomplete date information of the task when the task indicates a task state of on-hold.

14. The computer-readable non-transitory recording medium according to claim 6, the computer-executable program instructions when executed further causing the computer to execute operations comprising:
estimating an execution frequency of the task by using a task name and an occurrence date included in the task information.

15. The computer-readable non-transitory recording medium according to claim 6, the computer-executable program instructions when executed further causing the computer to execute operations comprising:
retrieving the task information from the revised task information, wherein the task information comprises a designated task for the person in charge.

16. The computer-readable non-transitory recording medium according to claim 15, wherein the retrieving further comprises extracting an unfinished task of a previous person in charge.

17. The computer-readable non-transitory recording medium according to claim 6, the computer-executable program instructions when executed further causing the computer to execute operations comprising:
generating textual data describing the task for transferring the task from the person in charge of the task to another person.

18. The computer-readable non-transitory recording medium according to claim 6,
wherein the revising further comprises inserting a predetermined value to the incomplete date information of the task when the task indicates a task state of on-hold.
